(19) United States
(12) Patent Application Publication
(10) Pub. No.: US 2014/0063677 A1
(43) Pub. Date: Mar. 6, 2014

(54) PROTECTION DEVICE

(71) Applicant: INNOLUX CORPORATION, Miao-Li County (TW)

(72) Inventors: BO-FENG CHEN, Miao-Li County (TW); CHIH-LUNG LIN, Tainan City (TW)

(73) Assignee: INNOLUX CORPORATION, Miao-Li County (TW)

(21) Appl. No.: 13/950,887

(22) Filed: Jul. 25, 2013

(30) Foreign Application Priority Data
Aug. 28, 2012 (TW) 101131152

(51) Int. Cl. H02H 7/20

(52) U.S. Cl. CPC H02H 7/20
USPC 361/212

(57) ABSTRACT

This disclosure provides a protection device for a display having a panel. The protection device includes a voltage generator coupled to the panel, configured for generating at least one common voltage; and a discharge unit coupled to the voltage generator, configured for discharging charges on the voltage generator when the display is turned off.

This application claims the benefit of Taiwan application Serial No. 101131152, filed Aug. 28, 2012, the disclosure of which is incorporated by reference herein in its entirety.

### TECHNICAL FIELD

The present disclosure relates to a protection circuit, and more particularly, to a display with the protection circuit to alleviate possible cold start flickers and cold start image sticking of the display.

### TECHNICAL BACKGROUND

The liquid-crystal display (LCD) has been intensely developed for years. Of the LCDs, the TFT LCD is a variant of LCD which uses the thin-film transistor (TFT) technology to improve image addressability and contrast. The TFT LCD has many advantages such as low radiation, low power consumption and compact size. FIG. 1 schematically shows a circuit diagram of a pixel and its driving circuit in a prior-art TFT LCD. The LCD pixels are manufactured in a two-dimensional grid, and the driving circuit is used to control the liquid-crystal (LC) molecules in each pixel. The driving circuit includes a LC capacitor C_{LC}, a storage capacitor C_{ST}, a TFT with its gate connected to a scan line S_{N}, its source connected to a data line D_{M}, and its drain connected to both the LC capacitor C_{LC} and the storage capacitor C_{ST}. The storage capacitor C_{ST} is used to store charges for driving the LC molecules, so as to stabilize the operation in the LCD. The LC capacitor C_{LC} and the storage capacitor C_{ST} are connected in parallel to a node of common voltage Vcom.

The common voltage Vcom behaviors as a reference voltage to build up an electrical field in the LCD pixel. Ideally, brightness on the pixel will be the same no matter it is driven by a positive-polarity or negative-polarity driving voltage. However, due to the feed-through or charge-injection effect in the LCD, the pixel-capacitor-based voltage may be shifted in a certain extent, causing asymmetry between the positive-polarity and negative-polarity driving voltages applying to the liquid crystal molecules. In such a case, a common voltage Vcom can be used to adjust the driving signal to be symmetric in its positive and negative parts, so that the LCD can work in an optimum condition. Regarding the swing in the data-line signal, a DC or AC voltage may be applied to the node of common voltage Vcom to drive the pixel to change its grey level.

In the case when the LCD is shut down, electric charges may distribute and accumulate at the node of common voltage Vcom thereof. The charges may build up an electrical field E1 to affect the distribution of positive ions 30 and negative ions 31 in the pixel, which is schematically illustrated in FIG. 2. A built-in electrical field E2 is also formed due to the pixel voltage Vpixel and the common voltage Vcom. If the LCD is then turned on again, the built-in electrical field E2 may unbalance the bias voltage in the pixel, leading problems like cold start flicker and cold start image sticking. If a built-in field has formed in the pixel before the LCD turned on, the bias voltage in the pixel should be asymmetrical when the LCD is turned on. This may cause the LCD to fail in the flicker test and referred to as the cold start flicker. Also, this may cause the ion aggregation to accumulate on the LCD panel, which may further cause the image-sticking or after-image phenomena. This situation can be named as the cold start image sticking.

Therefore, it is in need to develop a new protecting means to keep the LCD away from the above-described problems including the cold start flicker and the cold start image sticking.

### TECHNICAL SUMMARY

This disclosure is to provide a protecting circuit to alleviate the problems including the cold start flicker and the cold start image sticking of the display.

This disclosure is to provide a protecting circuit to discharge the charges accumulating on a display when it is turned off in a short time, and to keep the display away from the charge accumulation thereon, which may cause a possible electric field formed in the display panel.

According to one aspect of the present disclosure, one embodiment provides a protection device for a display having a panel. The protection device includes a voltage generator coupled to the panel, configured for generating at least one common voltage; and a discharge unit coupled to the voltage generator, configured for discharging charges on the voltage generator when the display is turned off.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 schematically shows a circuit diagram of a pixel and its driving circuit in a prior-art TFT LCD.

FIG. 2 schematically shows a charge distribution in a prior-art display panel when the display panel is turned off.

FIG. 3 schematically shows a circuit diagram of a protection device according to an embodiment of this disclosure.

FIG. 4 schematically shows a circuit diagram of a protection device according to another embodiment of this disclosure.

FIG. 5 schematically shows a generated common voltage of a display panel with the discharge unit of the embodiment after the display panel is turned off, in comparison with the one without the discharge unit.

FIG. 6 shows measured results of the common voltage of several display panels, with or without the discharge unit of the above embodiments.

FIG. 7 schematically shows a charge distribution in a display panel with the discharge unit of the embodiment after the display panel is turned off.

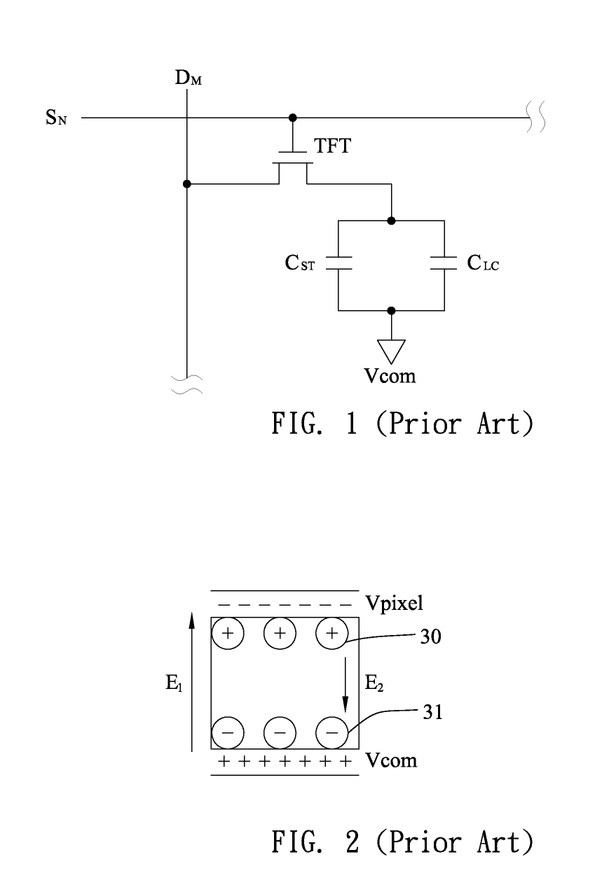

### DESCRIPTION OF THE EXEMPLARY EMBODIMENTS

For further understanding and recognizing the fulfilled functions and structural characteristics of the disclosure, several exemplary embodiments cooperating with detailed description are presented as the following. Reference will now be made in detail to the preferred embodiments, examples of which are illustrated in the accompanying drawings. Although the terms “first”, “second” and “third” are used to describe various elements, these elements should not be limited by the term. Also, unless otherwise defined, all terms are intended to have the same meaning as commonly understood by one of ordinary skill in the art.

FIG. 3 schematically shows a circuit diagram of a protection device according to an embodiment of this disclosure. The protection device can be used in a display apparatus with a panel 13. The protection device includes a voltage generator 11 and a discharge unit 12. The voltage generator 11 is coupled to the panel 13 and used to generate a common voltage Vcom. The discharge unit 12 is coupled to the voltage generator 11 and used to discharge charges gathering on the voltage generator 11 when the display apparatus is turned off. The display apparatus can be a liquid-crystal display (LCD) in the embodiment.

The voltage generator 11 may be a buffer circuit composed of an amplifier op1 and a plurality of resistors. In the embodiment, the plurality of resistors of the voltage generator 11 includes a first resistor R₁ and a second resistor R₂, and the amplifier op1 has an inverting input terminal, a non-inverting input terminal and an output terminal. One end of the first resistor R₁ is connected to a power supply of voltage V_{DD}, and the other end is connected to both the second resistor R₂ and the non-inverting input terminal of the amplifier op1. One end of the second resistor R₂ is connected to both the first resistor R₁ and the non-inverting input terminal, and the other end is held at ground (0 V) directly. Considering the amplifier op1, its inverting input terminal is coupled to its output terminal, and its output terminal is further coupled to the common voltage Vcom and the discharge unit 12. The first resistor R₁ and the second resistor R₂ can be variable resistors, so as to adjust the common voltage Vcom according to the practical requirements for the device design. In the embodiment, the discharge unit 12 may include a resistor R₃ with its resistance in a range from about 0.1 kΩ to about 1000 kΩ.

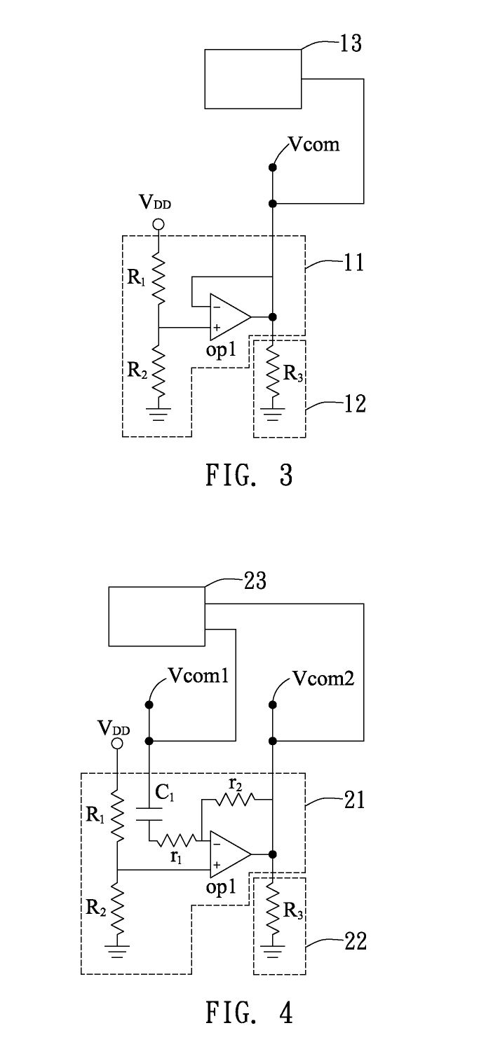

FIG. 4 schematically shows a circuit diagram of a protection device according to another embodiment of this disclosure. The protection device can be used in a display apparatus with a panel 23. The protection device includes a voltage generator 21 and a discharge unit 22. The voltage generator 21 is coupled to the panel 23 and used to generate a first common voltage Vcom1 and a second common voltage Vcom2. The discharge unit 22 is coupled to the voltage generator 21 and used to discharge charges gathering on the voltage generator 21 when the display apparatus is turned off. The display apparatus can be a LCD in the embodiment.

The voltage generator 21 may be a feedback circuit composed of an amplifier op1, a capacitor C₁, and a plurality of resistors. In the embodiment, the plurality of resistors of the voltage generator 21 includes a first resistor R₁, a second resistor R₂, a third resistor R₁, and a fourth resistor r₂, and the amplifier op1 has an inverting input terminal, a non-inverting input terminal and an output terminal. One end of the first resistor R₁ is connected to a power supply of voltage V_{DD}, and the other end is connected to both the second resistor R₂ and the non-inverting input terminal of the amplifier op1. One end of the second resistor R₂ is connected to both the first resistor R₁ and the non-inverting input terminal, and the other end is grounded. One end of the third resistor r₁ is coupled to the capacitor C₁, and the other end is coupled to the inverting input terminal of the amplifier op1. The fourth resistor r₂ may be interposed between the inverting input terminal and the output terminal of the amplifier. Moreover, the first common voltage Vcom1 is applied to the capacitor C₁, so the capacitor C₁ receives the first common voltage Vcom1. The capacitor C₁ is connected to the third resistor r₁ to generate the first common voltage Vcom1, and the output terminal of the amplifier op1 is connected to the discharge unit 22 to generate the second common voltage Vcom2. In the embodiment, the discharge unit 22 may include a resistor R₃ with its resistance in a range from about 0.1 kΩ to about 1000 kΩ.

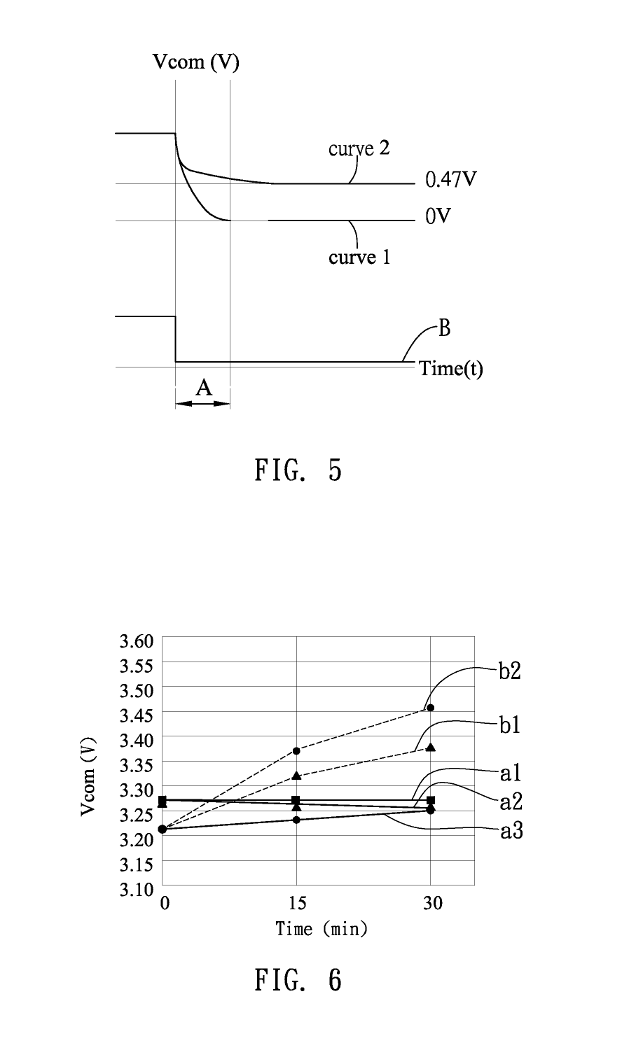

FIG. 5 schematically shows a generated common voltage Vcom of a display panel with the discharge unit of the above embodiments after the display panel is turned off, in comparison with the one without the discharge unit. Referring FIG. 5, when the display panel is shut down at the time A, the one with the discharge unit 12 or 22 can discharge the charges thereon, so that the common voltage Vcom can be reduced to 0 V (at the ground voltage) in a very short time. The curve 1 in FIG. 5 represents such a case. On the other hand, as to the one without the discharge unit 12 or 22, the charges accumulating on the voltage generator 11 or 21 cannot be released away quickly, so the remaining charges may render the common voltage Vcom reduced to a certain voltage value, such as 0.47 V. The curve 2 in FIG. 5 represents an exemplary case. As a consequence, the display panel with the discharge unit 12 or 22 of the embodiment can discharge the charges on the voltage generator 11 or 21 in a more efficient way, in comparison with the one without the discharge unit.

FIG. 6 shows measured results of the common voltage Vcom of several display panels, with or without the discharge unit of the above embodiments. The display panels are turned on and then turned off repeatedly in every 15 minutes. The common voltage Vcom of the display panels without the discharge unit may rise up as the number of times of being switched on and off increases; for example, the curves b1 and b2. On the other hand, the common voltage Vcom of the display panels with the discharge unit does not raise but keep stable as the number of times of being switched on and off increases; for example, the curves a1, a2 and a3. As can be observed in FIG. 6, the optimum common voltage Vcom can be about 3.25 V.

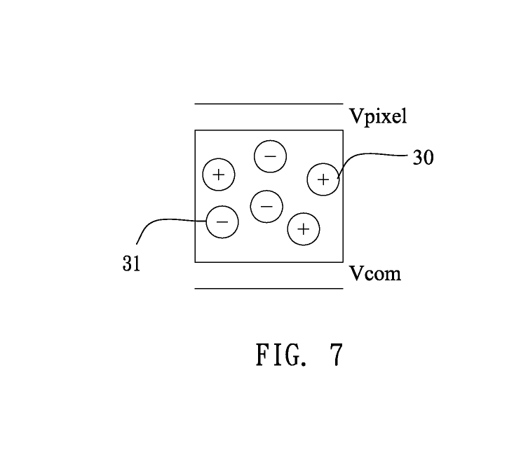

FIG. 7 schematically shows a charge distribution in a display panel with the discharge unit of the above embodiments after the display panel is turned off. The ion aggregation is discharged, so no built-in field can be formed in the panel.

In the embodiments, a discharging path is designed for being interposed between the voltage generator and the ground, so that the charges accumulating on the display panel, when it is turned off, can be released away in a very short time. This keeps the display panel away from the charge accumulation thereon, which may cause a possible electric field formed in the pixel and hence a residue image or an after image displayed by the panel. Also, it keeps the display panel away from the breakdown due to repeatedly being switched on and off. In this disclosure, the resistance of the resistor in the discharge unit can be arranged according to the panel size, to improve the display efficiency and the displayed image quality. Moreover, the discharge unit of the embodiments may improve the selectivity of the polyimide (PI) material in the electronic products of in-plane switching (IPS).

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A protection device for a display having a panel, the protection device comprising:
a voltage generator coupled to the panel, configured for generating at least one common voltage; and
a discharge unit coupled to the voltage generator, configured for discharging charges on the voltage generator when the display is turned off.

2. The protection device according to claim 1, wherein the voltage generator comprises a buffer circuit composed of an amplifier and a plurality of resistors.

3. The protection device according to claim 2, wherein the plurality of resistors comprise a first resistor and a second resistor in series connection, and the amplifier has an inverting input, a non-inverting input coupled to the plurality of resistors, and an output coupled to the inverting input.

4. The protection device according to claim 3, wherein the output of the amplifier is coupled to the discharge unit to generate the at least one common voltage.

5. The protection device according to claim 2, wherein the plurality of resistors comprise a variable resistor, so as to adjust the at least one common voltage.

6. The protection device according to claim 1, wherein the voltage generator comprises a feedback circuit composed of an amplifier, a capacitor, and a plurality of resistors.

7. The protection device according to claim 6, wherein the plurality of resistors comprise a first resistor, a second resistor connected to the first resistor in series, a third resistor and a fourth resistor, and the amplifier has a non-inverting input coupled to the first resistors, an inverting input and an output, one end of the third resistor coupled to the capacitor and the other end coupled to the inverting input, the fourth resistor interposed between the inverting input and the output of the amplifier.

8. The protection device according to claim 7, wherein the at least one common voltage includes a first common voltage and a second common voltage, in which the capacitor is connected to the third resistor to generate the first common voltage, and the output of the amplifier is connected to the discharge unit to generate the second common voltage.

9. The protection device according to claim 1, wherein the discharge unit comprises a resistor.

10. The protection device according to claim 9, wherein the resistor has a resistance in a range from 0.1 kΩ to 1000 k Ω.

11. The protection device according to claim 1, wherein the display is a liquid-crystal display (LCD).
